(19) United States
(12) Patent Application Publication
(10) Pub. No.: US 2008/0069497 A1
(43) Pub. Date: Mar. 20, 2008

(54) Optical waveguide tap monitor

(76) Inventors: Yann Tissot, (US); Marc Epitaux, Sunnyvale, CA (US); Hans Georg Limberger, (US); Rene-Paul Salathe, (US)

Correspondence Address: INTEL/BLAKELY, 1279 OAKMEAD PARKWAY, SUNNYVALE, CA, 94085-4040, US

(21) Appl. No.: 11/521,982

(22) Filed: Sep. 15, 2006

(51) Int. Cl. G02B 6/34

(52) U.S. Cl. 385/37

(57) ABSTRACT

A refractive index grating is formed in an optical waveguide. A detector has an incident light surface that is oriented at about a right angle to a longitudinal axis of the waveguide. The surface is positioned upstream of the grating and outside of the waveguide to receive reflected light from the grating. An index matching material fills essentially the entirety of the light path for the reflected light, from an outside surface of the waveguide to the detector's incident light surface. Other embodiments are also described and claimed.

An embodiment of the invention is related to techniques for monitoring the power level of optical signals that are propagating in an optical waveguide. Other embodiments are also described.

### BACKGROUND

There are many reasons for detecting and monitoring the power level of an optical signal that is propagating in a waveguide. For instance, consider the situation where multiple optical channels are transmitted over a single-mode fiber through a process known as wavelength-division multiplexing (WDM). In WDM, there are multiple, forward propagating optical signals or channels, each assigned to a different wavelength of light, that have been launched or injected into the fiber at the source or transmitter. Typically, a separate laser source is used to generate the signal for each channel. There may, however, be discrepancies in power level between the launched signals of the different channels, because fine alignment of the laser sources is needed over a large range of wavelength (for example, 30 nanometers for C-Band). Accordingly, active monitoring of the power level for a given channel is desirable at a bottom level of the transmitter stage, and more particularly at the interface between the laser source and the optical fiber.

To allow for monitoring the power of a given propagating signal, some of the signal of the given channel has to be coupled out of the fiber core. Commonly used techniques to produce such optical taps include micro-bending, side polishing or chemical etching which physically alter the outside surface of the fiber to allow some of the propagating signal to leak out. These, however, involve the use of several additional mechanical pieces which limits the ability to integrate such devices very close to the laser source.

Another type of optical tap uses a Fiber Bragg Grating (FBG) that is formed within the optical fiber, to direct some of the propagated light signal out of the fiber core in a dispersive way. By tilting the grating plane of the FBG, a small portion of the propagating light signal is coupled out of the fiber core. In one case, the grating is highly tilted at an angle of 45 degrees with respect to the optical axis of the waveguide. Out-coupled signals from this FBG are directed onto a pair of optical detectors that are oriented parallel to the optical axis, where they are added together to form a power monitoring output signal.

In another case, the FBG is tilted less than 15 degrees, and a lens or focusing means is provided to bring the out-coupled light to a focus at a predetermined location outside the fiber, where the detectors are located. For example, the focal length of the lens may be in the range of 8 centimeters, where the detector array is disposed about 8 centimeters from a mirrored lens.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows a conceptual diagram of an optical waveguide tap apparatus, according to an embodiment of the invention.

FIG. 2 illustrates details of the operation of a TFBG used in an embodiment of the invention.

FIG. 3 shows the direction of out-coupled light from the TFBG.

FIG. 4 illustrates an example transmission spectrum of the TFBG that is Bell-like.

FIG. 5 shows the transmission spectrum of a TFBG that has a quasi flat transmission over a limited spectral range.

FIG. 6 illustrates the wavelength dependence of P_{TAP} provided by an integrated fiber tap monitor, in accordance with an embodiment of the invention.

FIG. 7 is a schematic of an example integrated fiber tap monitor, in accordance with an embodiment of the invention.

FIG. 8 is a picture of a prototype integrated fiber tap monitor.

FIG. 9 is a block diagram of a date routing device that includes an integrated optical power tap monitor.

FIG. 10 shows another example of a quasi flat transmission spectrum of a TFBG.

FIG. 11 illustrates a superstructure TFBG used to extend the detection wavelength range in an embodiment of the invention.

### DETAILED DESCRIPTION

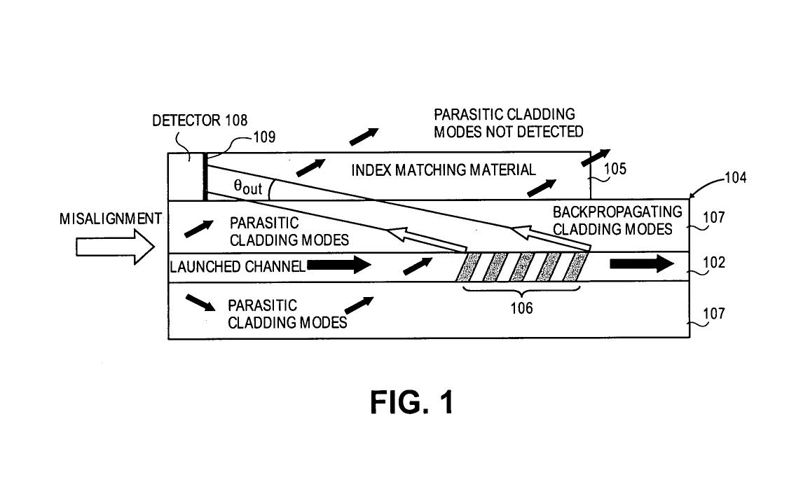

In a conventional optical fiber tap monitor, light is coupled out of the fiber core and focused onto an array of detectors that are parallel to the axis of the optical fiber. If implemented close to the propagating signal source, this configuration may suffer from cross talk that is due to forward propagating cladding modes that have been generated by misalignment of the communications signal source with the fiber core. Moreover, the focusing unit used in some of these conventional optical taps limits miniaturization of the device. It would therefore be desirable to be free of such shortcomings when placing an optical tap close to the signal source. FIG. 1 shows an optical tap monitor or apparatus, in accordance with an embodiment of the invention, that may be more suitable for miniaturization and integration with the signal source.

In FIG. 1, an optical waveguide 104 is depicted in which a refractive index grating 106 has been formed. In this embodiment, the waveguide 104 is an optical fiber having a core 102 and a cladding 107, with the grating formed in the core 102. Note the forward propagation direction of the launched channel signal (also referred to as a “core mode”) that is incident upon the grating 106. The arrow points from an upstream position to a downstream position along the waveguide longitudinal axis. Also, note the presence of parasitic cladding modes propagating in generally the same direction as the launched channel and that cannot be completely eliminated at a point upstream of the grating. These may have been caused by source misalignment (at a point upstream of the grating 106), or by other aspects inherent to free space optics such as laser beam quality, lens quality, and focusing.

A detector 108 whose main incident light surface 109 is oriented at about a right angle to the longitudinal or optical axis of the waveguide 104 is provided. The detector may be comprised of one or more photodiodes. In one embodiment, the detector is sized and positioned to sense the light spot for, in general, only one channel at a time. The incident light surface 109 is positioned upstream of the grating 106 and outside of the waveguide 104 as shown, to receive reflected light (here, back propagating cladding modes out-coupled by index matching material 105) from the grating 106. The position of the detector 108 and its surface 109 may be optimized for sensing a single channel. This may be in accordance with the elevation angle θₒᵤₜ of the reflected and out-coupled light path as shown (and as further discussed below).

An index matching material 105 fills essentially the entire light path for the reflected light, starting at least from an outside surface of the waveguide (just upstream of the grating) to the detector incident light surface 109. The index matching material 105 should be selected so as to allow the back propagating cladding modes to couple out of the fiber cladding 107 and onto the detector's incident light surface 109. This material may be a gel or a liquid, or, in the embodiment described below, a type of solidified glue or adhesive which also serves to reinforce the fixing of the detector 108 in relation to the waveguide 104. In the embodiment where the optical waveguide comprises an optical fiber including a core 102 and a cladding 107, the index matching material 105 is in contact with the outside surface of the cladding 107 as shown in FIG. 1. Note how the index matching material 105 is also in contact with a substantial portion of the main incident light surface 109 of the detector. Such a continuous region of index matching material avoids the need for any focusing element for the back propagating cladding modes.

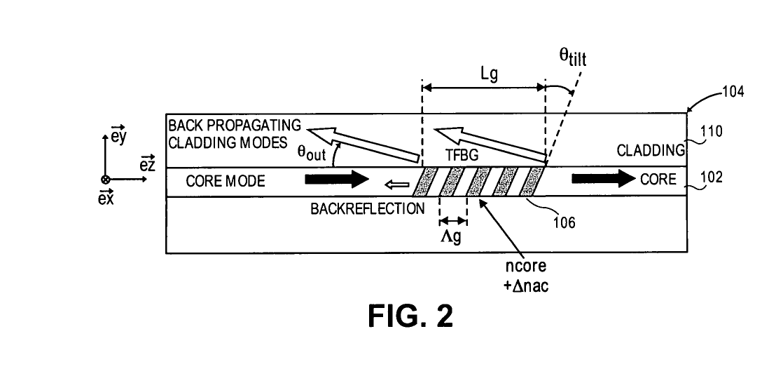

As mentioned above, the forward propagating parasitic cladding modes can severely influence the signal level produced by the detector, if the detector incident light surface were placed parallel to the grating. However, by orienting the detector surface approximately perpendicularly to the fiber axis and upstream of the grating, forward propagating cladding mode cross talk is significantly reduced and more efficient detection is possible for particularly low grating tilt angles of less than 20 degrees (see FIG. 2). This yields a versatile optical tap monitor that also has relatively low polarization dependence. Although the monitor can be placed essentially anywhere along the waveguide, it can advantageously be placed relatively close to the channel signal source, thereby allowing miniaturization and integration of a transmitter or transceiver.

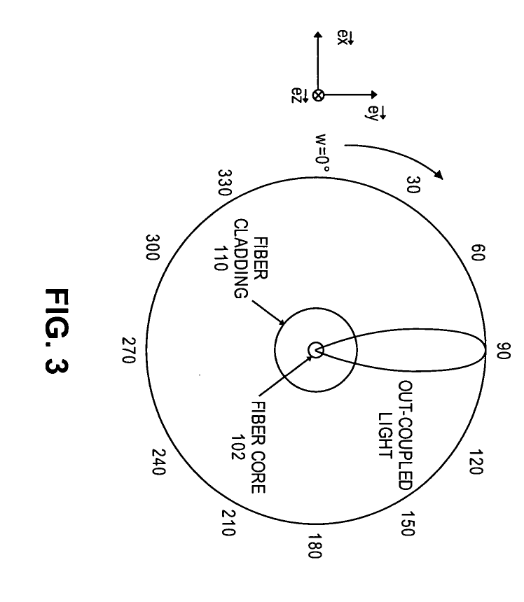

Turning now to FIG. 2, details of the operation of a tilted FBG (TFBG), relevant to the optical tap monitor, are shown. The TFBG may be formed using known technology, by taking advantage of the ultraviolet photosensitivity of a fiber core to produce optical filters that have relatively sharp spectral characteristics. The FBG in general is a periodic modulation of the index of refraction in the fiber core. It may be created using the photosensitivity of fiber glass to ultraviolet light (between 150-350 nanometers) or femtosecond laser light (around 800 nanometers, second and third harmonics). An FBG acts as a selective filter since reflection at each plane of modulation act constructively, leading to an efficient back-reflection in the core. A tilted FBG has an index modulation that is not normal to the fiber axis (note the angle shown in FIG. 2 as θₜᵢₗₜ). This leads to the selective coupling of light out of the fiber core into back propagating cladding modes and to reduce the core mode back reflection. The tilt angle θₜᵢₗₜ and the grating pitch Λ_{g} determine the spectral width of the out-coupled light. The magnitude of the induced index modulation (Δn_{ac}), and the length of the grating L_{g}, determine the out-coupling intensity. Light is out-coupled in the longitudinal direction at an angle θₒᵤₜ, and in the azimuthal direction at an angle ψ=90° with respect to the eₓ axis (as illustrated in FIG. 3), e.g. along the e_{y} axis. Thus, the detector surface (see FIG. 1) should be appropriately positioned both longitudinally and in the azimuthal plane, to receive sufficient reflected light (out-coupled light) from the grating, to sense the power of the launched channel in the optical waveguide.

The position of the detector relative to the longitudinal axis of the waveguide may be given by the following relationship for elevation angle θₒᵤₜ:

$$cos {θ}_{out} ( λ ) = \frac{\frac{λ}{{Λ}_{g}} cos ( {θ}_{tilt} ) - {n}_{eff}^{core}}{{n}_{external}}$$

where n^{core} is the effective index of refraction of the waveguide at the grating, and nₑₓₜₑᵣₙₐₗ is the index of refraction of the index matching material. Thus, the detector should be located at a position that provides the desired detected power, according to the elevation angles θₒᵤₜ related to the detected wavelength band (variable λ).

When using a tunable light source to transmit multiple, forward propagating (core mode) channels, the channels are time sliced. In that case, each channel is out-coupled at a peculiar elevation angle θₒᵤₜ. Therefore, if the detector is sufficiently large for covering the elevation angle range corresponding to the out-coupled wavelength band, then each channel is sensed properly. For example, a wavelength band of more than 40 nm can be sensed with a detector that is about 1 mm wide.

When using a communication system that transmits multiple propagating channels simultaneously (not time sliced), each channel is out-coupled simultaneously. Regardless of the detector surface, all of the out-coupled light spots in that case may overlap on the detector surface. This means the device may be unable to sense channels independently. As an example when sensing three channels where two of them are well balanced in power but not the third one, since all the optical tap signals are overlapping on the same detector surface, one cannot say which channel among the three sensed has a power issue. A solution in that case is to dedicate a single detector surface to a single, desired channel. Several detectors or an array of detectors can also be used in such a case, to detect multiple channels.

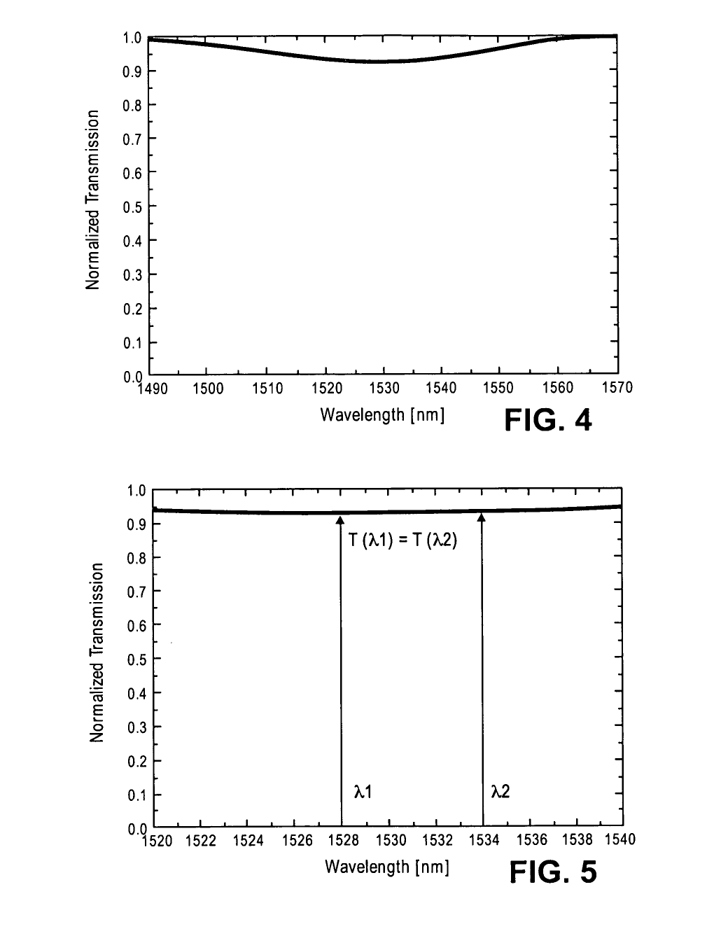

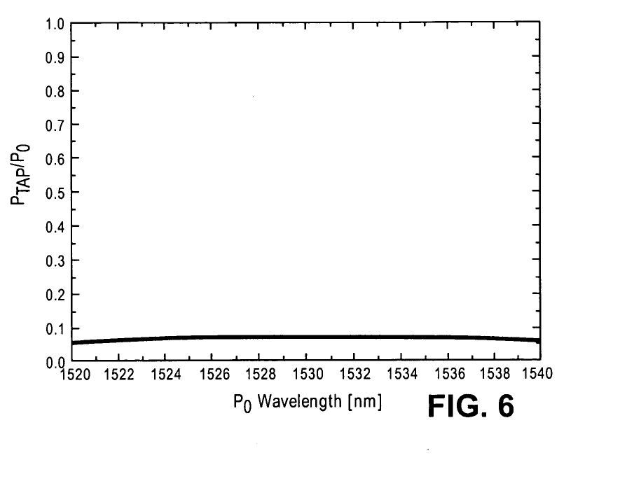

According to an embodiment of the invention, the tapped light signal that is incident on the detector is essentially wavelength independent and is linear to the injected signal power. This may be achieved by designing the TFBG to have a quasi flat transmission spectrum, over a limited spectral range. This is in contrast to a Bell-like spectrum depicted in FIG. 4. FIG. 5 shows an example, quasi flat transmission over a detection wavelength range. Note how the transmission spectrum has been flattened, that is, the slope of the Bell curve in FIG. 4 has been reduced, to exhibit less than five percent variation over the detected wavelength range. This can be achieved using a combination of different techniques. For instance, the period of the grating Λ_{g} may be varied, the mean index of refraction within the grating may be varied, or the tilt angle may be varied along the grating or by a superposition of gratings with different parameters. This is referred to as a period, index, or tilt angle chirp. In another technique, the amplitude of the index of refraction that has been induced along the fiber grating is varied. This is referred to as apodization. Chirp and apodization may be combined. Yet another way to obtain a quasi flat transmission spectrum is to induce a low coupling coefficient for the grating. The quasi flat spectrum allows better correlation of the power that has been detected by the detector (P_{TAP}) with the power that has been injected into the waveguide (P₀) as illustrated in the example plot of FIG. 6 which shows P_{TAP} normalized by P₀, i.e. P_{TAP}/P₀, as a function of injected wavelength. Note how the tap signal P_{TAP} is essentially proportional to P₀.

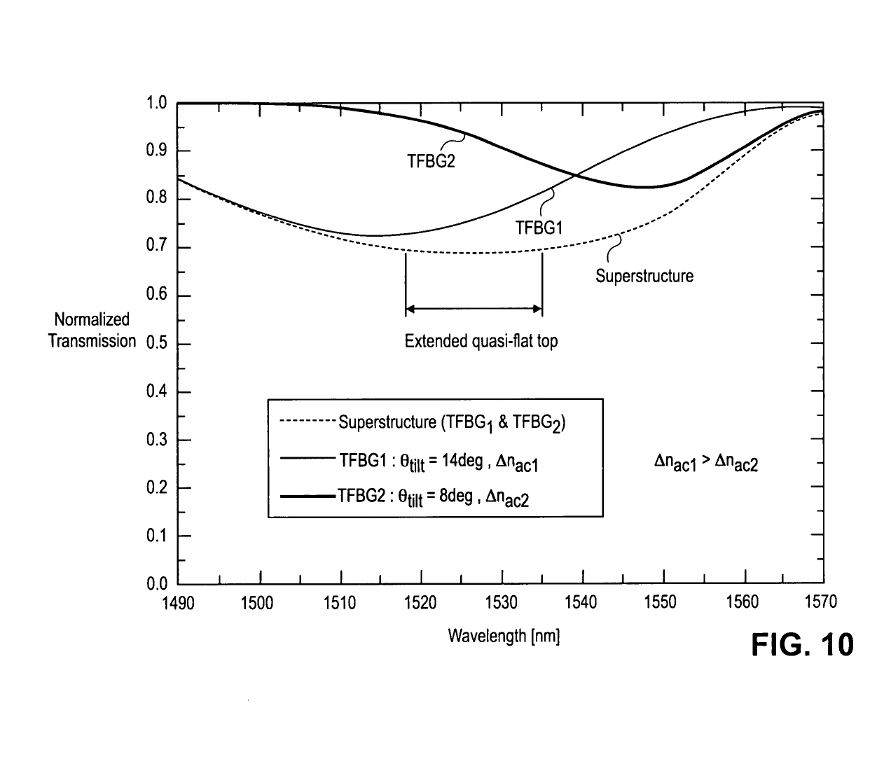

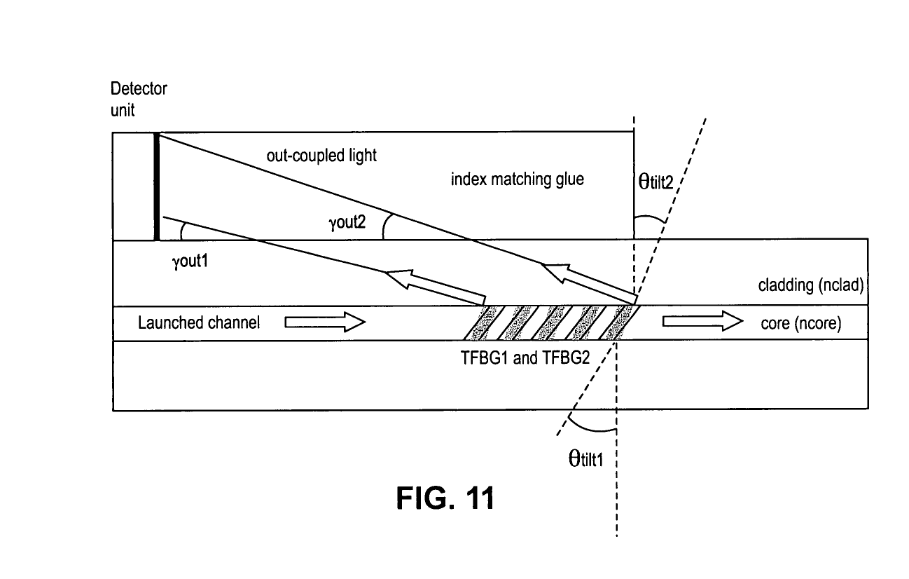

Another technique for expanding the “quasi-flat” spectrum of the optical power tap over a larger wavelength range is as follows (referring now to FIGS. 10 and 11). The transmission spectrum of TFBG (e.g., one having a bell-like shape as in FIG. 4) shifts to a lower wavelength when increasing the tilt angle θₜᵢₗₜ and does not change much in shape over a short tilt angle range (e.g. from 6 to 20°). Therefore, it is possible to combine several spectra, for flattening the overall transmission spectrum over a broader wavelength range, as illustrated in FIG. 10. In this example, this can be made by inscribing several TFBGs that have different tilt angles and that are superimposed (also known as grating “superstructure”) or spaced a few hundreds of micrometers. In FIG. 10, there are two TFBGs, one tilted at 14° and the other at 8°. The amplitude of the refractive index induced (Δnac) should be adapted to the combination of the different TFBGs, for obtaining a quasi-flat top spectrum.

Light at a single wavelength λ₁ may be out-coupled by each of n TFBGs at n different elevation angles (γₒᵤₜ₁, γₒᵤₜ₂, . . . γₒᵤₜₙ) as illustrated in FIG. 11. Note that a type of tilted, superstructure FBG has been used for designing a spectrometer based on the Fourier-transform of the interference pattern formed by two out-coupled beams of a single wavelength, as described in “Tilted superstructure fiber grating used as a Fourier-transform spectrometer”, Optical Letters 29, Vol. 14, 1614, 2004 Wielandy, Dunn. In the proposed embodiment, interference effect is not measured since the tap signal is integrated on a single large area detector.

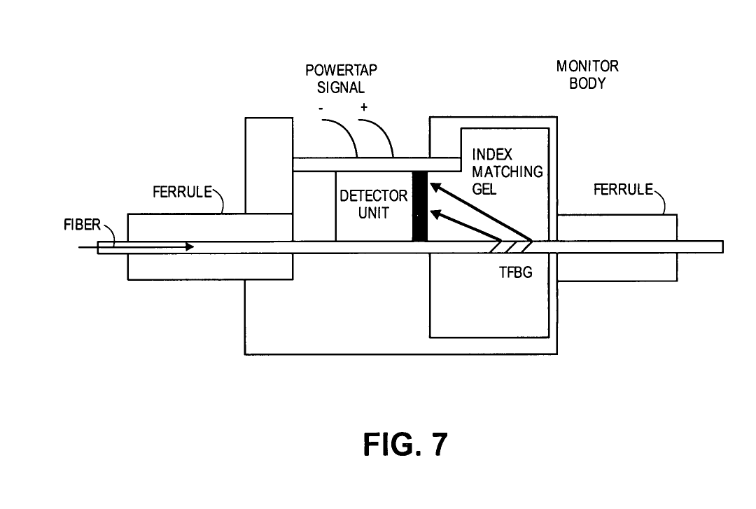

Turning now to FIG. 7, a schematic of an integrated fiber tap apparatus is shown in accordance with an embodiment of the invention. The fiber waveguide (comprising a cladding surrounding a core) is held by a ferrule that aligns and protects the fiber as it passes through the optical tap apparatus as shown. The ferrule has been cutback inside the body of the apparatus, to expose the fiber as shown. A detector unit is fixed in contact with the fiber, with its main incident light surface being at about 90 degrees to the longitudinal axis (fiber axis). The detector unit can be held in place by an index matching gel that has been filled to entirely surround the fiber and, in particular, the region where the TFBG is located. A pair of conductors are also connected to the detector unit to provide the electrical signal representing the detected power tap signal. Note the arrows indicating the light path from the TFBG to the detector unit.

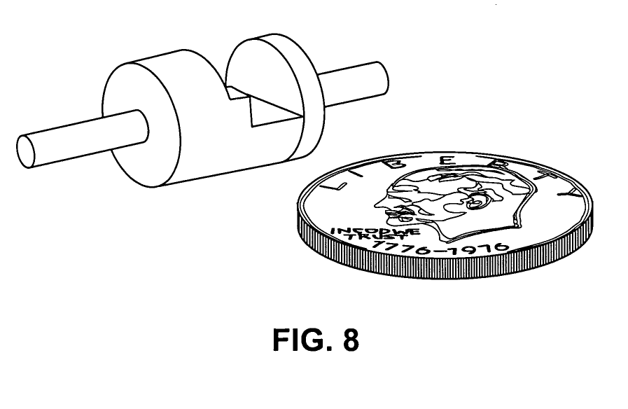

In accordance with another embodiment of the invention, the region that is filled by the index matching material is shaped (e.g., sloped) in order to limit the background noise that comprises reflections of forward propagating cladding modes at the interfaces between the index matching material and air within the optical tap apparatus. Some of this background noise can be incident on the detector's main incident light surface, by multiple reflections or scattering. A tap monitor, in accordance with an embodiment of the invention, is insensitive to parasitic reflection from downstream systems such as connectors. FIG. 8 shows the picture of a prototype of an integrated fiber tap apparatus consistent with the schematic of FIG. 7.

The integrated fiber tap apparatus described above may provide a true measure of the power that has been injected into a waveguide. This technology may be used for dynamic alignment of the light that is coupling into a fiber core, for example. Alternatively, it could be used for precise power monitoring of tunable and non-tunable transmitters. It could also be used as part of a variable optical attenuator module.

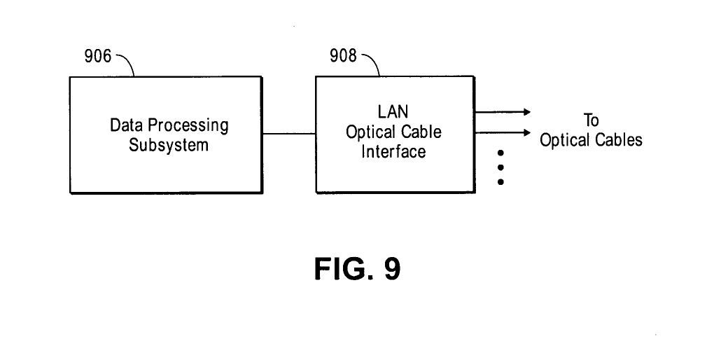

FIG. 9 shows a system application of the power tap monitor described above, in the form of a data routing device. The data routing device may be a switch or a router that can process and forward data packets. As an alternative, the device may be one that passes time division multiplexed (TDM) signals. The data routing device has a data processing subsystem 906 that may have a CPU and memory that are programmed to process data traffic that is routed by the device. Incoming and outgoing data traffic are via optical cables (not shown) that are connected to a local area network (LAN) optical cable interface 908 of the routing device. The interface 908 is designed for LAN optical cables which may be used in short distance optical links, in contrast to long distance or long-haul optical cables such as those typically used by telecommunication companies and long-haul fiber optic networks. The interface 908 may include discrete optical subassemblies or transceiver packages in which the power tap monitor is integrated. In addition, the interface 908 may also include an integrated, LAN optical cable connector (that mates with one attached to the optical cable). Also, serializer-deserializer circuitry may be provided that serializes packets from the data processing subsystem 906 for transmission, and deserializes a received bit stream from the optical cables into, for example, multiple byte words in the format of the data processing subsystem 906. The data processing subsystem 906 operates on such packets to determine, for example, a destination node to which the packet will be forwarded, using a routing algorithm, for example, and/or a routing table.

The invention is not limited to the specific embodiments described above. For example, although the figures show an embodiment of the optical power tap apparatus for an optical fiber, the concepts are also applicable to other types of optical waveguides. Also, the invention is not limited to precisely the angles or positions shown in the figures, as there is a practical tolerance band. For instance, the orientation of the detector surface may be slightly less than 90 degrees, or slightly greater, and still provide the power tap signal with the desired immunity from parasitic forward propagating cladding modes and any associated background noise. Accordingly, other embodiments are within the scope of the claims.

1. An optical waveguide tap apparatus comprising:
an optical waveguide in which a first refractive index grating is formed; and
a detector whose incident light surface is oriented at a right angle to a longitudinal axis of the waveguide, the detector's incident light surface being positioned upstream of the grating and outside of the waveguide to receive reflected light from the grating, wherein an index matching material is in the entirety of a light path for the reflected light, from an outside surface of the waveguide to the detector's incident light surface wherein the grating has at least one of the group consisting of a sufficiently low coupling coefficient, chirped grating, and apodization along its grating, so as to exhibit a quasi-flat transmission over the wavelength operation range of the detector.

2. The optical waveguide tap apparatus of claim 1 wherein a tilt angle of the refractive index grating relative to the longitudinal axis is less than 20 degrees.

3. (canceled)

4. The optical waveguide tap apparatus of claim 2 further comprising a light communications signal source coupled to the waveguide at a position upstream of the detector's incident light surface, the signal source having been manufactured to be in the same equipment enclosure as the optical waveguide and the detector.

5. The optical waveguide tap apparatus of claim 1 wherein the detector is located at a position according to an elevation angle related to a detection wavelength band, downstream of a channel launching position on the waveguide.

6. The optical waveguide tap apparatus of claim 1 wherein the index matching material fills a region that is shaped between the detector's incident light surface and the grating to reduce background noise sensed by the detector.

7. The optical waveguide tap apparatus of claim 1 further comprising a plurality of refractive index gratings formed in the waveguide and tilted at different angles, each grating being positioned close to each other or superimposed so that the detector's incident light surface can receive its out-coupled light.

8. The optical waveguide tap apparatus of claim 7 wherein the tilt angles of the first and other gratings are up to 20°.

9. An optical transmitter comprising:
a ferrule
an optical fiber that passes through the ferrule, the ferrule having a cutback region that exposes the fiber, the fiber and having a first tilted Fiber Bragg Grating (TFBG) therein that is tilted less than 20 degrees and has at least one of the group consisting of a sufficiently low coupling coefficient, chirped grating. and apodization along its grating, as to exhibit a quasi-flat transmission over a multi- wavelength operating range of the transmitter and
a photodiode fixed in relation to the fiber and held in place within the ferrule by a continuous region of index matching material that is in contact with a main incident light surface of the photodiode at one end and fills the cutback region and is in contact with an outside surface of the optical fiber adjacent to the TFBG at another end, the main incident light surface of the photodiode being positioned at ninety degrees relative to a longitudinal axis of the fiber to receive reflected light from the TFBG.

10. The optical transmitter of claim 9 wherein the optical fiber comprises a core and a cladding, the index matching material being in contact with an outside surface of the cladding.

11. (canceled)

12. The optical transmitter of claim 10 wherein the photodiode is located at a vertical position according to an elevation angle related to a detected wavelength band, downstream of a channel launching position on the fiber.

13. The optical transmitter of claim 10 wherein the photodiode is immune against light that is reflected back from a system that is downstream of the TFBG.

14. The optical transmitter of claim 9 further comprising a second TFBG in the optical fiber tilted at a different angle than the first TFBG positioned to provide its out-coupled light to the detector through the index matching material.

15. The optical transmitter of claim 14 wherein the tilt angles of the first and second TFGBs are up to 20°.

16. A data routing device comprising:
a data processing subsystem to process data traffic forwarded by the device; and
an interface to single mode optical fiber cable, the data processing system to process data traffic forwarded by the device over the cable, in accordance with wavelength division multiplexing, and wherein
the interface has an optical transceiver in which an optical fiber has a tilted Fiber Bragg Grating (TFBG) therein, wherein the TFBG is tilted less than 20 degrees and the TFBG has at least one of the group consisting of a sufficiently low coupling coefficient, chirped grating, and apodization along its grating, to exhibit a quasi-flat transmission that exhibits less than five percent variation in a detected WDM band, and a an optical power tap monitor having a detector whose main incident light surface is oriented at an angle that is in the range of 45 degrees to 135 degrees relative to a longitudinal axis of the fiber as measured from a point downstream of the main incident light surface, the detector being located upstream of the TFBG and outside of the fiber to receive reflected light from the TFBG, and an index matching material in the entirety of a light path for the reflected light, from an outside surface of the fiber to the main incident light surface.

17. (canceled)

18. The data routing device of claim 16 wherein the optical fiber comprises a core and a cladding, the index matching material being in contact with the outside surface of the cladding.

19. The data routing device of claim 17 wherein the detector is located at a position according to elevation angles related to the detected WDM band, downstream of a channel launching position on the optical fiber.
